(19) United States
(12) Patent Application Publication
(10) Pub. No.: US 2009/0165290 A1
(43) Pub. Date: Jul. 2, 2009

(54) METHOD OF MAKING BATTERY USING AS CASE WITH ALUMINIUM MULTILAYERED FILMS

(76) Inventors: Si-chul Yu, Gyeonggi-do (KR); Jong yong Lee, Seoul (KR)

Correspondence Address: John W. Renner;RENNER, OTTO, BOISSELLE & SKLAR, 1621 Euclid Avenue, 19th Floor, Cleveland, OH, 44115, US

(21) Appl. No.: 12/307,950

(22) PCT Filed: Jun. 28, 2007
(86) PCT No.: PCT/KR2007/003135

§ 371 Date: Jan. 8, 2009

(30) Foreign Application Priority Data
Jul. 14, 2006 (KR) 1020060066349
Jan. 17, 2007 (KR) 1020070005225

(51) Int. Cl. H01M 2/02

(52) U.S. Cl. 29/623.2

(57) ABSTRACT

A method of manufacturing a cell using a pouch of aluminum multilayered film is disclosed. The pouch of an aluminum multilayered film is used as the outer case of the cell. The method includes: inserting an electrode assembly, which is composed of a negative electrode, separator, and positive electrode, in the pouch; sealing the electrode assembly; and bending the sealed portion of the cell once or twice. Therefore, the present invention can enhance the safety and energy density of the cell.

### TECHNICAL FIELD

The present invention relates to technology of a cell. More particularly this invention relates to a method of manufacturing a cell, which manufactures the outer case of the cell using a pouch of an aluminum multilayered film, inserts an electrode assembly, which is composed of a negative electrode, separator, and positive electrode, in the pouch, seals it, and bends the sealed portion of the cell once or twice, thereby enhancing the safety and energy density of the cell.

### BACKGROUND ART

In general, cells are classified into a primary cell and a rechargeable cell. Primary cells are mostly manufactured as a cylindrical shape, and rechargeable cells are manufactured as a cylindrical or square shape. The square cell employs a pouch of a metal can or an aluminum multilayered film for its outer case.

The cylindrical cell and the can-type square cell are each made by being assembled with a can and a cap. The can is made of stainless steel or aluminum.

The cylindrical cell is manufactured as follows: After manufacturing an winding-type electrode assembly where a negative electrode, a separator, and a positive electrode are wound, or an rod electrode assembly, the electrode assembly is put in a cylindrical can and then an electrolytic solution is poured thereinto. The leads, attached to the negative and positive electrodes, or the rod are connected to a cap assembly and a cylindrical can. And, beading and creeping are performed to tightly connect the cap assembly and the cylindrical can.

The square cell is manufactured as follows: After manufacturing a winding-type electrode assembly where a negative electrode, a separator, and a positive electrode are wound or a stacked-type electrode assembly, the electrode assembly is put in a square can and then the leads are connected to the cap assembly. After that, an electrolytic solution is poured therein and then the can is sealed.

In particular, the conventional cylindrical and square lithium-based secondary cells have disadvantages in that they are manufactured through complicated processes, as the cap assembly and the leads, attached to the positive and negative electrodes, are welded to the cylindrical can, etc. Also, the cells may suddenly explode due to their malfunctions. When such an explosion occurs, the metal cases are very dangerous to users.

In addition, the conventional method of manufacturing a cell has problems as follows: The can weight and the waste of cap margin require scarification of energy density per weight and volume. For example, the pouch-type square second cell is manufactured in such a way that: after manufacturing a winding-type electrode assembly where a negative electrode, a separator, and a positive electrode are wound or an stacked-type electrode assembly, the electrode assembly is processed by the deep drawing and then put in a square recess formed in the case. After that, an electrolytic solution is poured in the case. The leads and the case are thermally bound to seal them vacuumly. However, since the sealing portion between the tap and the pouch takes a certain area in the manufactured square cell, it lowers the energy density.

Furthermore, the conventional method is rarely applied to other types of cells other than the square type. Also, since a vacuum sealing must be performed to apply a certain pressure to the electrode assembly, and a recess must be formed through the deep drawing that requires a predetermined pressure applied to the case, the case must be formed at a constant thickness and, in particular, it is difficult to form the recess when the drawing depth is deep, which are the drawbacks of the conventional method.

Meanwhile, Korean Patent Application No. 10-2004-0083654 discloses a proposal where elliptical and cylindrical cells can be manufactured from a pouch through the deep drawing. However, since the recess must be formed in a state where the case undergoes constant pressure to perform the deep drawing, the proposal has a problem that a relatively thick pouch must be used. Also, the proposal still has a difficulty to form a recess, as the drawing depth is much deeper than the recess is.

### DISCLOSURE OF THE INVENTION

### Technical Problem

Therefore, the present invention has been made in view of the above problems, and it is an object of the present invention to provide a method of simply manufacturing a cell whose energy density and safety are enhanced, in which a pouch of an aluminum multilayered film is used for the cell outer case.

### Technical Solution

In accordance with an aspect of the present invention, the above and other objects can be accomplished by the provision of a method of manufacturing a cell whose outer case uses an aluminum multilayered film. The method includes: preparing an electrode assembly wound by an electrode layer that is composed of a negative electrode, a positive electrode, and a separator positioned between the negative electrode and the positive electrode; pouring electrolytic solution in the electrode assembly; and sealing the electrode assembly into which the electrolytic solution was poured.

Here, sealing the electrode assembly includes: wrapping the electrode assembly with a pouch and binding end portions of the pouch; simultaneously, binding leads protruded from one side or both sides of the electrode assembly, a binding polymer, and the pouch, together, and sealing them; and bending the leads twice.

Also, sealing the electrode assembly may include putting the electrode assembly in a cylindrical or elliptical can made of a pouch. The pouch refers to the aluminum multilayered film.

Preferably, the pouch is formed in such a way that its one side is coated with aluminum to form a binding layer, and its other side forms an insulating layer as being coated with insulating material in a single layer or multi-layers. Preferably, the binding layer is selected from among polyolefin group, polyimide (PI), polyvinylchloride (PVC), polyvinylidene fluoride (PVDF), polyvinyl alcohol (PVA), and polyethyleneoxide (PEO), or a compound mixed with two or more selected from among the same.

Preferably, the insulating layer is one selected from polyethylene terephthalate (PET) and nylon, or a compound mixed with them.

The biding layer and insulating layer may be formed by various components according to types of cells. Therefore, the components for the biding layer and insulating layer will not be limited to the above-listed components.

### ADVANTAGEOUS EFFECTS

As the method according to the present invention can manufacture cylindrical and square cells whose outer case uses a pouch, its manufacturing processes can be simplified and its energy density enhanced. Also, the safety and cost-effectiveness are also increased. Therefore, the conventional cells whose outer case uses a metal can can be replaced with the cells whose outer case uses a pouch.

### DESCRIPTION OF DRAWINGS

The above and other objects, features, and other advantages of the present invention will be more clearly understood from the following detailed description taken in conjunction with the accompanying drawings, in which:

FIG. 1A is a perspective view illustrating a cylindrical electrode assembly including a shaft according to the present invention;

FIG. 1B is a perspective view illustrating a square winding-type electrode assembly according to the present invention;

FIG. 1C is a perspective view illustrating a square stacked-type electrode assembly according to the present invention;

FIG. 2A is a view illustrating, in order, processes of a method for manufacturing a cylindrical cell by a pouch extending manner, according to an embodiment of the present invention;

FIG. 2B is a view illustrating, in order, processes of a method for manufacturing a cylindrical cell by a pouch folding manner, according to an embodiment of the present invention;

FIG. 3A is a view illustrating, in order, processes of a method for manufacturing a cylindrical cell by a pouch extending manner, according to another embodiment of the present invention;

FIG. 3B is a view illustrating, in order, processes of a method for manufacturing a cylindrical cell by a pouch folding manner, according to another embodiment of the present invention;

FIG. 4A is a front view illustrating a cylindrical cell manufactured through a pouch extending manner, according to an embodiment of the present invention;

FIG. 4A is a front view illustrating a cylindrical cell manufactured through a pouch folding manner, according to an embodiment of the present invention;

FIG. 5A is a front view illustrating a cylindrical cell manufactured through a pouch extending manner, according to an another embodiment of the present invention;

FIG. 5A is a front view illustrating a cylindrical cell manufactured through a pouch folding manner, according to an another embodiment of the present invention;

FIG. 6A is a rear view illustrating a pouch for manufacturing a cylindrical cell according to the present invention;

FIG. 6B is a rear view illustrating a pouch for manufacturing a square cell according to the present invention;

FIG. 7 is a side view of a cylindrical cell or a square cell, which is undergone by a two-step bending process, according to the present invention;

FIG. 8A is a front view of the cylindrical cell or the square cell of FIG. 7, which is undergone by a pouch extending manner according to the present invention;

FIG. 8B is a front view of the cylindrical cell or the square cell of FIG. 7, which is undergone by a pouch folding manner according to the present invention;

FIG. 9 is a front view of the cylindrical cell or the square cell of FIG. 8 to describe ending processes;

FIG. 10 is a front view of the cylindrical cell of FIG. 4B, which is undergone by a two-step bending process, according to the present invention;

FIG. 11 is a front view of the cylindrical cell of FIG. 5B, which is undergone by a two-step bending process, according to the present invention;

FIG. 12 is voltage vs. capacity graphs for AAA sized cylindrical cells that are manufactured by Embodiment 1 and Compared Example 1, according to the present invention;

FIG. 13 is a life time graph for an AAA sized cylindrical cell that is manufactured by Embodiment 1 according to the present invention; and

FIG. 14 is a life time graph for a square cell that is manufactured by Embodiment 2 according to the present invention.

### BRIEF DESCRIPTION OF SYMBOLS IN THE DRAWINGS

1: pouch

2: electrode assembly

11: pouch finished portion

12: pouch extended portion

13: pouch folded portion

14: cell finished portion

21: lead

22: binding polymer

23: bent portion

### BEST MODE

Now, preferred embodiments of the present invention will be described in detail with reference to the accompanying drawings.

### Manufacturing Electrode Assembly

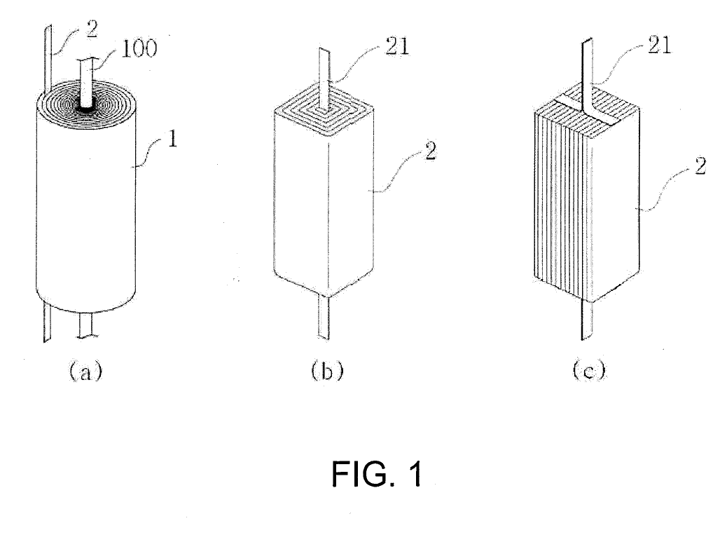

An electrode assembly has a winding type of structure where a negative electrode, a separator, and a positive electrode are wound, as shown in FIGS. 1A and 1B. As well, the electrode assembly has a stacked type of structure as shown in FIG. 1C.

The winding-type electrode assembly 2, as shown in FIGS. 1A and 1B, is manufactured in such a way that an electrode layer 1 is wound around the shaft 100 and then separated from the shaft 100, thereby forming a cylindrical shape. Here, a fixing pin 21 may be placed in the position in which the shaft 100 was.

The stacked-type electrode assembly 2, as shown in FIG. 1C, is manufactured in such a way that a negative electrode, a separator, and a positive electrode are sequentially and repeatedly stacked. Here, a separator may be formed as pieces located between the electrodes. As well, the separator may be formed as a continuous form located between electrodes and step up them in a zigzag formation, or to wind around the electrodes.

### Pouring and Dipping of Electrolytic Solution

After preparing the electrode assembly 2, it is dipped in an electrolytic solution or an electrolytic solution is poured into it. Here, pouring an electrolytic solution may be performed after the electrode assembly 2 is put in a cylindrical or elliptical can fabricated by using a pouch, which will be described later.

### Sealing

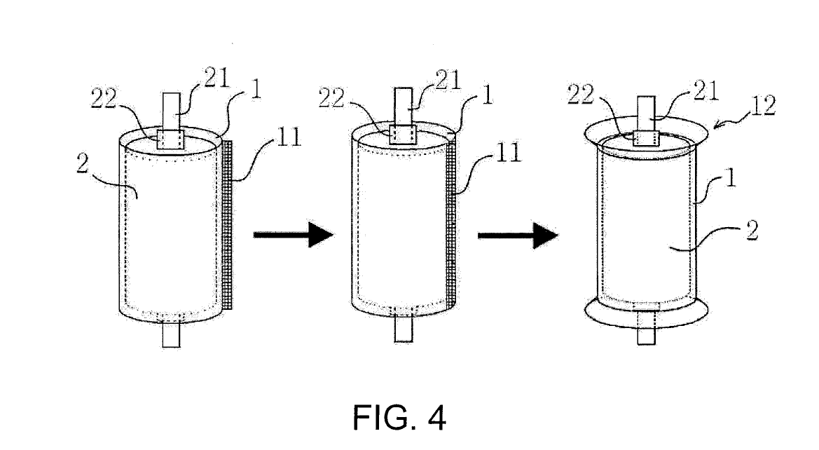

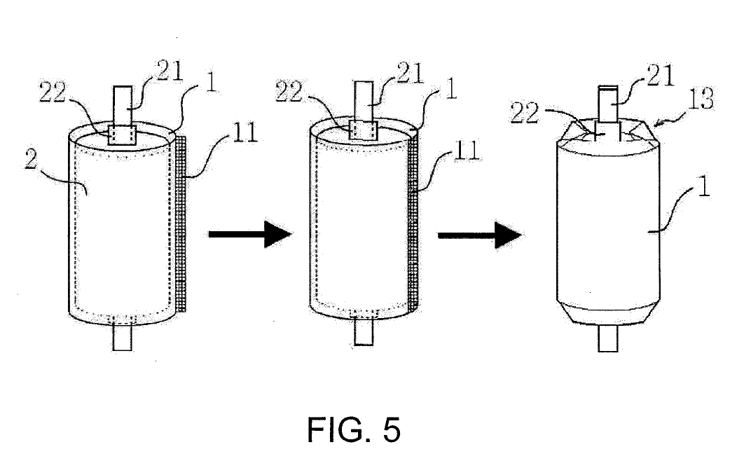

After undergoing pouring and dipping of an electrolytic solution, the electrode assembly 2 is processed, as shown in FIGS. 4A or 5A, in such a way that binding polymer 22 of insulating and melting properties is applied, at 50˜200° C., to the leads 21 protruded from one side of the electrode assembly 2 or both protruded from both sides of the electrode assembly 2.

The binding polymer 22 strengthens the leads 21 as conductors, which are led from the negative and positive electrodes. When the binding is performed under 50° C., the binding polymer 22 imperfectly binds to the leads 21. But, when the binding is performed over 200° C., the binding polymer 22 melts and irregularly binds to the leads 21. Therefore, it is preferable that the binding of the binding polymer 22 is performed within the range of 50˜200° C.

The electrode assembly 2 bound by the binding polymer 22 is put in a pouch 1 previously manufactured. After that, the pouch 1, the leads 21 of the electrode assembly 2, and the binding polymer 22 are thermally bound, at 50˜250° C., together and simultaneously, and then sealed.

When the thermal bond temperature is under 100° C., the bound portion may be easily detached due to low heat. On the other hand, when the thermal bond temperature is above 250° C., the pouch 1 or the binding polymer 22 may melt and fail to maintain their form. Therefore, it is preferable that the binding of the binding polymer 22 is performed within the range of 100˜250° C.

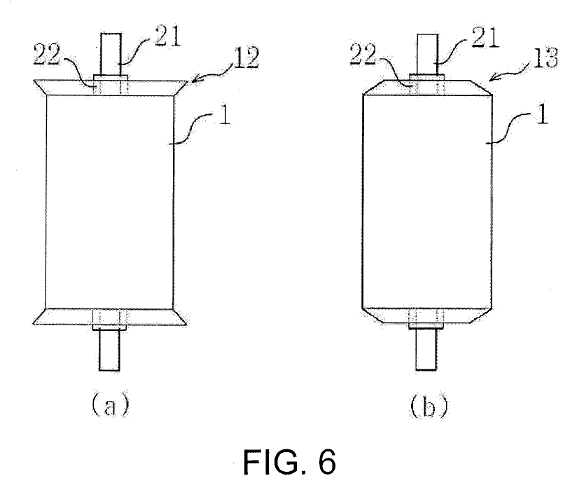

The sealing process is identical to a bending process except for the following, regarding a method for manufacturing a cylindrical or square cell: The cylindrical cell uses a cylindrical pouch as shown in FIG. 6A, and the square cell uses an elliptical pouch as shown in FIG. 6B. Therefore, the sealing process lo will be described based on the cylindrical cell, for description convenience.

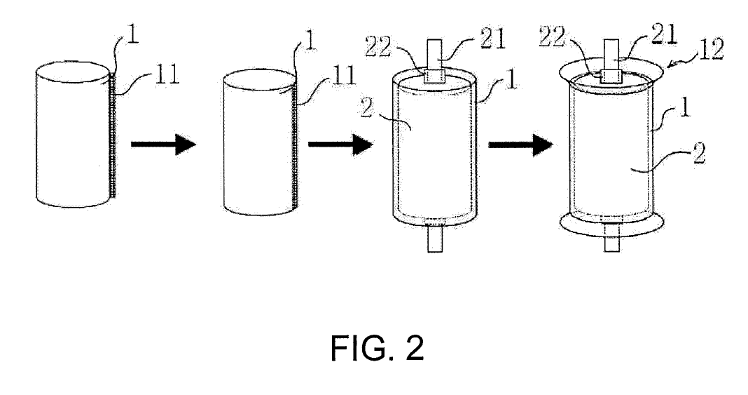

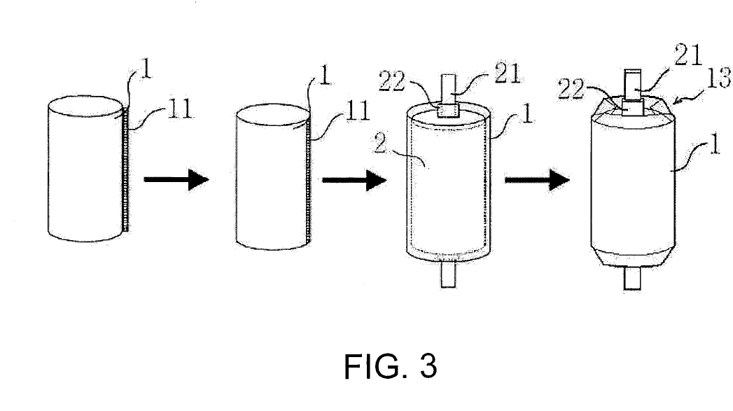

The following is a detailed description of the sealing process based on the cylindrical cell as shown in FIGS. 2A and 2B or 3A and 3B.

As shown in FIG. 2A or 2B, a pouch 1 of aluminum multilayered film is manufactured as a cylindrical shape. A pouch finished portion 11 protrudently formed at the side of the cylindrical pouch 1 is bound to the pouch body using a bond. The electrode assembly 2 is put in the cylindrical pouch 1. One end portion or both end portions of the pouch receiving the electrode assembly 2 are extended to form a pouch extending portion 12 or a pouch folding portion 13. After that, the pouch extending portion 12 or the pouch folding portion 13 is thermally bound to seal the both sides of the cell.

As shown in FIG. 3A or 3B, an electrode assembly 2 is wound by a pouch 1. A pouch finished portion 11, protrudently formed at the side of the pouch 1 by thermal bond, is bound to the pouch body using a bond to be finished. One end portion or both end portions of the pouch receiving the electrode assembly 2 are extended to form a pouch extending portion 12 or a pouch folding portion 13. After that, the pouch extending portion 12 or the pouch folding portion 13 is thermally bound to seal both sides thereof.

The pouch finished potion 11, as shown in FIG. 6, serves to indicate a thermally bonded position of the cylindrical pouch, which is preferably located at the center of the thermal bond area of the pouch with respect to the top and bottom of the cell.

The pouch 1 is made of aluminum film whose sides are both coated with a binding material (binding layer) or an insulating material (insulating layer), whose components are not reacted with an electrolytic solution, in one layer or multi layers.

The binding layer has one selected from among polyolefin group, polyimide (PI), polyvinylchloride (PVC), polyvinylidene fluoride (PVDF), polyvinyl alcohol (PVA), and polyethyleneoxide (PEO), or a compound mixed with two or more selected from among the same.

The insulating layer has one selected from polyethylene terephthalate (PET) and nylon, or a compound mixed with them.

Since the biding layer and insulating layer may be formed by various components according to types of cells, the components for the biding layer and insulating layer will not be limited to the above-listed components.

The binding polymer 22 has one selected from among polyolefin group, polyimide (PI), polyvinylchloride (PVC), polyvinylidene fluoride (PVDF), polyvinyl alcohol (PVA), polyethyleneoxide (PEO), and polyethylene terephthalate (PET), or a compound mixed with two or more selected from among the same. The binding polymer 22 serves to bind the leads at one or both sides of the electrode assembly at 50˜200° C. Only if materials do not react with an electrolytic solution and can perform a sealing bond, they can be employed as the binding polymer 22.

The sealing process may be performed in such a way that a pouch 1 and a binding polymer 22 are thermally bound, at 100˜250° C., and sealed, while the cell is vacuuming by a vacuum wrapper.

The electrolytic solution pouring process and the sealing process may be performed in a controlled atmosphere (for example, in a box filled with an inert gas or in a dry room), if such an atmosphere is necessary to inhibit moisture.

### Bending Leads

As shown in FIGS. 4A and 4B or FIGS. 5A and 5B, when a pouch extending portion 12 or a pouch folding portion 13 is formed and then completely sealed, the leads 21 extended from one or both sides of the cell are bound with the pouch 1. However, the bound portions between the leads 21 and the pouch 1 have a problem in that they decrease energy density of the cell. To solve this, the leads 21 are bent once or twice using a bending device.

As shown in FIG. 4A or 5A, after forming the pouch extending portion 12, the leads at one side or at both sides of the cell are bent twice by a bending device. As shown in FIG. 4B or 5B, after forming the pouch folding portion 13, the leads at one side or at both sides of the cell are bent once by a bending device. Here, when the pouch folding portion 13 is formed, the cell does not have a protrudent portion.

The following is a detailed description of the bending process referring to in the drawings.

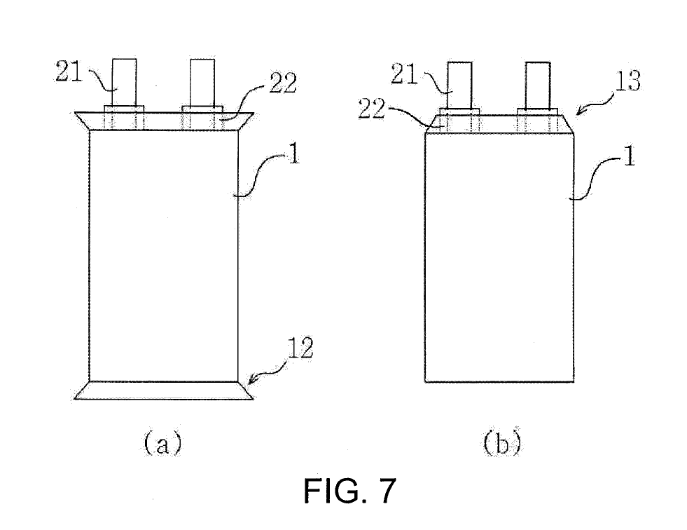

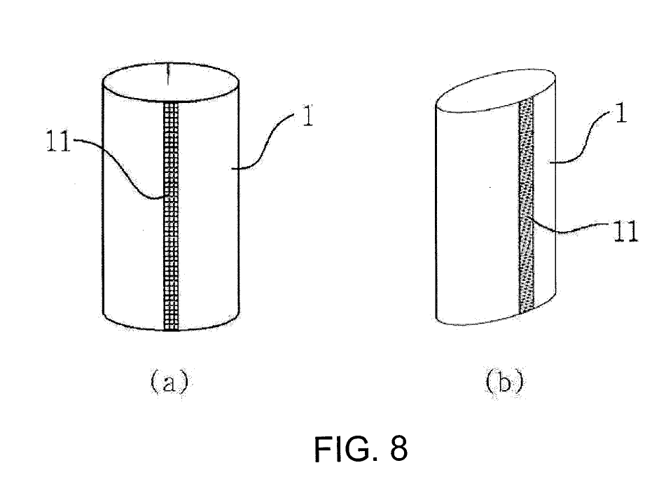

As shown in FIG. 7, a binding portion of the cell is firstly bent 90° to form a bent portion 23. The cell of the bent potion 23 depicts its front view in FIGS. 8A and 8B.

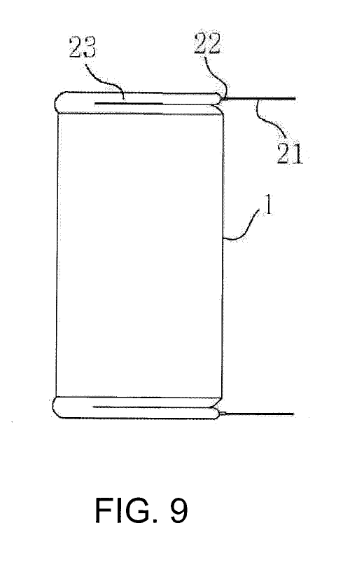

As shown in FIG. 8A, when a pouch extending portion is formed and a binding portion is bend 90°, the cell finished portion 14 is outwardly protruded to thusly decrease the energy density. To solve this problem, the cell finished portion 14 that is outwardly protrudent, is bent 180° in the arrow direction as shown in FIG. 9.

On the contrary, when a pouch folding portion 13 is formed, the cell does not have a protrudent portion as shown in FIG. 8B. In that case, the portion of the cell is bent once.

As well, the bent pouch 1 and the bent portion 23 including the leads 21 are firmly attached to the cell body using a strong adhesive.

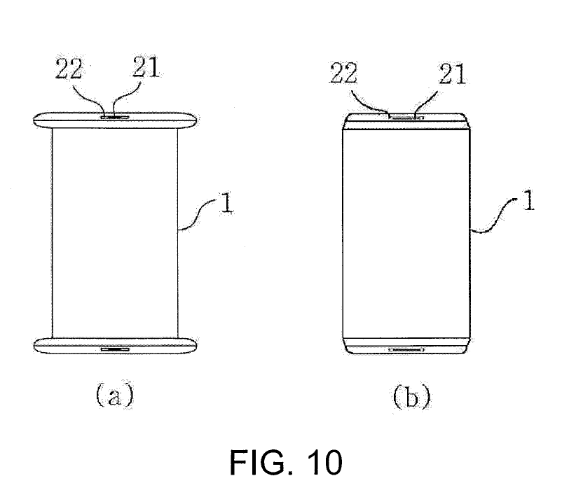

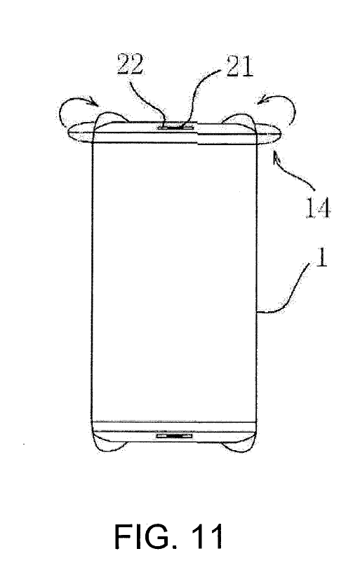

As described above, the problem of a decrease in energy density when bending the leads 21 can be resolved. Although the bending process is effective, it may be omitted considering its connection to the other devices for manufacturing the cell. Also, when the pouch folding portion 13 is formed, the portion is just bent once to manufacture the cell. However, when the pouch folding portion 13 is fabricated to be long for convenient manufacture, the portion may be bent twice as shown in FIGS. 10 and 11.

The present invention may become more easily understood through the following Embodiment 1 and Comparing Example 1.

### EMBODIMENT 1

### Manufacturing Cylindrical Lithium Ion Cell Whose Outer Case Uses Pouch

A negative electrode is manufactured in such a way that a cathode active material is implemented by graphite and a cathode plate is implemented by a copper foil. A positive electrode is manufactured in such a way that an anode active material is implemented by lithium cobalt oxide, LiCoO₂, and an anode plate is implemented by an aluminum film. As well, a separator is manufactured by a polyethylene (PE) porous film. These negative and positive electrodes and the separator are wound around a shaft of a winding device. The respective leads separately protruded from the top and/or bottom of the negative and positive electrodes are thermally bound at 130° C. using polyprophylene polymer, thereby preparing an electrode assembly.

The electrode assembly is dipped in an electrolytic solution (1M LiPF₆ in is EC/DEC (50:50 v %)) and then wound by a pouch film to bind end portions thereto at 180° C., thereby producing a cylindrical can including the electrode assembly. The leads from both sides and the pouch are thermally bound, at 180° C., using a binding polymer of polyprophylene, and then sealing is performed, thereby manufacturing a cell of AAA (10.5×44.5) size.

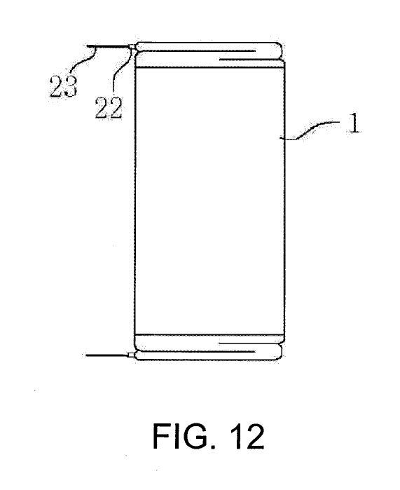

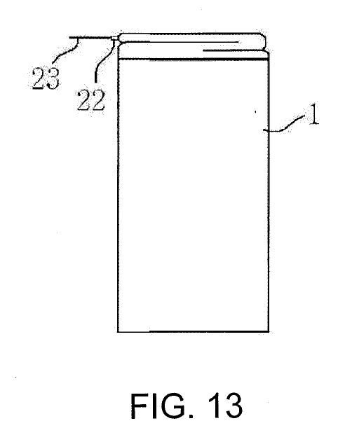

The sealed cell undergoes charge and discharge tests based on a current rate of 0.2C. The result, as shown in FIG. 12, shows that its capacity is 510 mAh, and its energy density is relatively high, such as 540 Wh/l and 208 Wh/kg. In addition, FIG. 13 shows a life time graph of the cell when it charges and discharges based on a current rate of 1C.

### EMBODIMENT 2

### Manufacturing Square Lithium Ion Cell Whose Outer Case Uses Pouch

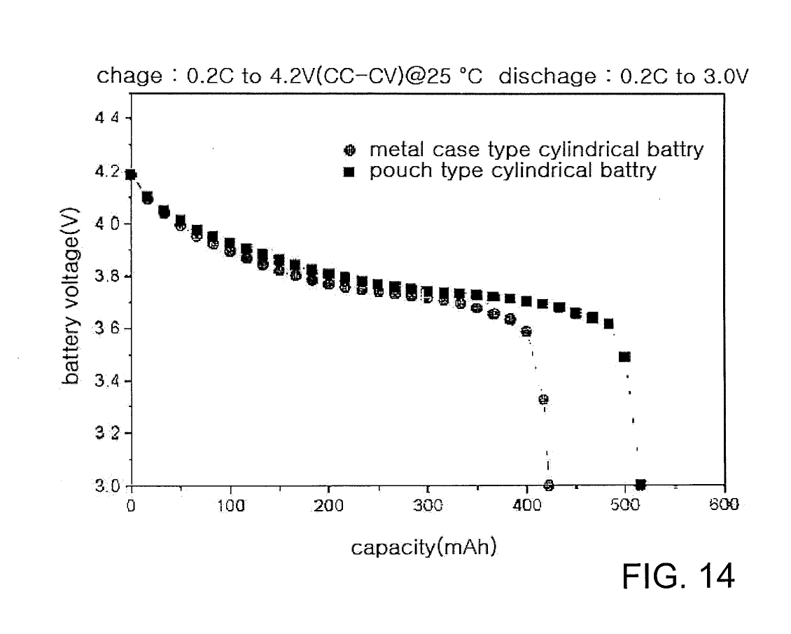

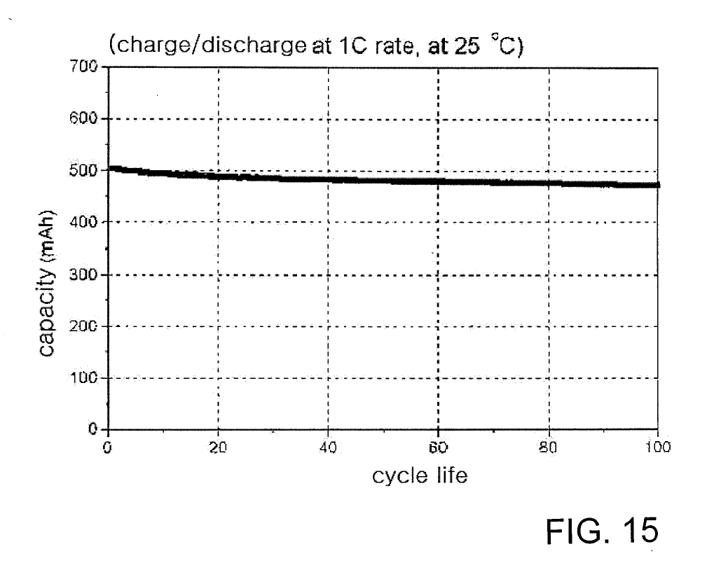

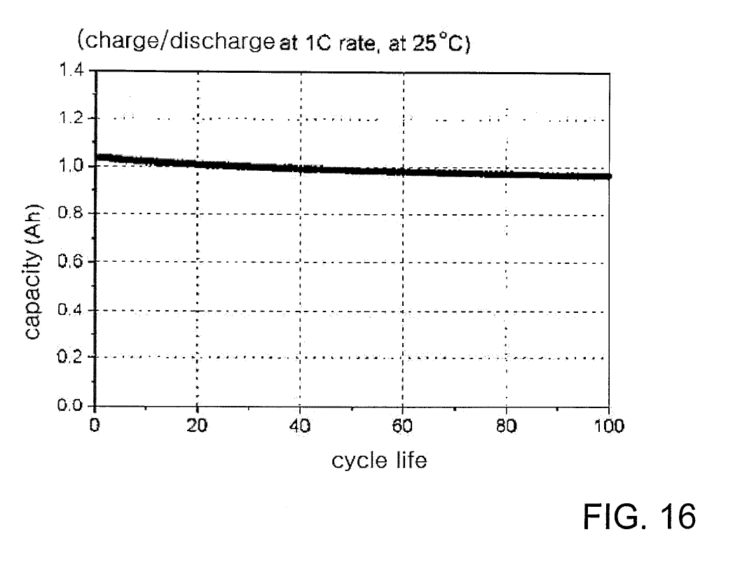

A square electrode assembly is prepared as the processes of Embodiment 1. The square electrode assembly is dipped in an electrolytic solution (1M LiPF₆ in EC/DEC (50:50 v %)) and then wound by a pouch film to bind end portions thereto at 180° C., thereby producing an elliptical can including the electrode assembly. The leads from both sides and the pouch are thermally bound, at 180° C., using a binding polymer of polyprophylene, and then sealing is performed, thereby manufacturing a cell of a certain size (5.2(T,mm)×34(W,mm)×50 (L, mm). The sealed cell undergoes charge and discharge tests. The result shows that its lo capacity is 1,050 mAh, and its energy density is relatively high, such as 440 Wh/l and 215 Wh/kg. Meanwhile, FIG. 14 shows a life time graph of the cell, with respect to up to 100 cycles, when it charges and discharges based on a current rate of 1C.

### COMPARING EXAMPLE 1

### Manufacturing Cylindrical Lithium Ion Cell Whose Outer Case Uses Stainless Steel

An electrode assembly is prepared as the processes of Embodiment 1. The electrode assembly is put in an AAA stainless steel cylindrical can. After that, an electrolytic solution (1M LiPF₆ in EC/DEC (50:50 v %)) is poured into the can. Next, the leads at the top and bottom are welded with a cap and the cylindrical can. Afterwards, a cap is covered with the cap and can and beading and creeping are performed, thereby manufacturing a cylindrical cell of AAA (10.5×44.5) size.

The cylindrical cell using the stainless steel can undergoes charge and discharge tests based on a current rate of 0.2C. The result, as shown in FIG. 12, shows that its capacity is 420 mAh and its energy density is 403 Wh/l, and 160 Wk/kg.

Therefore, the method according to the present invention can manufactures a cell using a pouch that is thinner than a can, lighter than a can, and does not have a portion corresponding to a cap, thereby enhancing the energy density per volume and per weight, compared with a conventional cell manufactured by a metal outer case.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, since the method of the present invention manufactures the outer case of the cell using a pouch, it can simplify cell manufacturing processes, enhance energy density, and thusly increase safety and cost-effectiveness. Therefore, the conventional cells whose outer case uses a metal can can be replaced with the cells whose outer case uses a pouch.

1. A method of manufacturing a cell whose outer case uses an aluminum multilayered film, comprising:
preparing an electrode assembly (2) wound by an electrode layer that is composed of a negative electrode, a positive electrode, and a separator positioned between the negative electrode and the positive electrode;
pouring electrolytic solution in the electrode assembly (2); and
sealing the electrode assembly (2) into which the electrolytic solution was poured,
wherein sealing the electrode assembly (2) comprises:
wrapping the electrode assembly (2) with a pouch (1) and binding end portions of the pouch (1), or putting the electrode assembly (2) in a cylindrical or elliptical can made of a pouch (1);
simultaneously, binding leads (21) protruded from one side or both sides of the electrode assembly (2), a binding polymer (22), and the pouch (1), together, and sealing them; and bending the leads (21) twice.

2. The method according to claim 1, wherein the pouch (1) is formed in such a way that its one side is coated with aluminum to form a binding layer, and its other side forms an insulating layer as being coated with insulating material in a single layer or multi-layers.

3. The method according to claim 2, wherein the binding layer is selected from among polyolefin group, polyimide (PI), polyvinylchloride (PVC), polyvinylidene fluoride (PVDF), polyvinyl alcohol (PVA), and polyethyleneoxide (PEO), or a compound mixed with two or more selected from among the same.

4. The method according to claim 2, wherein the insulating layer is one selected from polyethylene terephthalate (PET) and nylon, or a compound mixed with them.
